(19) United States
(12) Patent Application Publication
(10) Pub. No.: US 2006/0044466 A1
(43) Pub. Date: Mar. 2, 2006

(54) User interface system for presenting to a user the contents of an information carrier

(75) Inventors: Declan Patrick Kelly, Eindhoven (NL); Bei Wang, Shanghai (CN); Yang Peng, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/535,467

(22) PCT Filed: Oct. 31, 2003
(86) PCT No.: PCT/IB03/04911

§ 371 Date: May 17, 2005

(30) Foreign Application Priority Data
Nov. 20, 2002 (EP) 02292885.7

(51) Int. Cl. H04N 7/01

(52) U.S. Cl. 348/441

(57) ABSTRACT

The invention relates to a user interface system for presenting to a user the contents of an information carrier (101) intended to be inserted into a reading apparatus, said information carrier (101) containing data files having different content types and different coding formats, said user interface system comprising:—selection means(102) for selecting a set of data files (105), complying with the capabilities of said reading apparatus to play such data files (103), from among data files contained on said information carrier (101), —presentation means (107) for presenting a table of contents from the selected data files (105)

### FIELD OF THE INVENTION

The invention relates to a user interface system for presenting to a user the contents of an information carrier intended to be inserted into a reading apparatus.

The invention may be used for presenting the contents of any information carrier having the possibility of storing arbitrary data files, such as optical discs (DVD) and memory storage devices (Solid state memory cards, removable hard disks).

### BACKGROUND OF THE INVENTION

With the emergence of multimedia applications, there is increasing demand for data having different content types and/or coding formats (audio: MP3/WAV . . . , video: MPEG-2/MPEG-4 . . . , still picture: JPEG/BMP . . . , games . . . ) to be stored on one and the same information carrier to reduce the access time and to ease their use. This is the case for example, with DVD-ROM and CD-ROM optical discs on which arbitrary data files can be stored.

The reading of such information carriers by a personal computer is not a problem since every content type and coding format can be decoded on such an equipment. However, the reading of such information carriers on home consumer electronics players may be problematic. Indeed, the capabilities of home players differ widely from one product to another, so that not all data can be read and played by the user.

The user being not necessarily aware of the capabilities of his home player, he may try without success to make the home player play data files that are not supported. For example, a home player only supporting audio type data files cannot play data files comprising video data.

This makes the use of the home player inconvenient for the user.

### OBJECT AND SUMMARY OF THE INVENTION

It is an object of the invention to propose a user interface system for defining and presenting to a user the playable content of an information carrier inserted in a reading apparatus.

To this end, the user interface system according to the invention comprises:

selection means for selecting a set of data files, complying with the capabilities of said reading apparatus to play such data files, from among data files contained on said information carrier,
presentation means for presenting to the user, a table of contents from the selected data files.

The selection renders it possible to create a set of data files that can be played on the reading apparatus, since they fit the capabilities of the reading apparatus. Such a selected set of data files is used for creating the table of contents the user can access. This avoids the case where the user tries to play a data file for which the apparatus does not have the corresponding reading or decoding means.

By deduction, this selection means can also be used for creating the set of data files that cannot be played on the reading apparatus, thus informing the user about the limitations of the reading apparatus.

In a particular embodiment, the selection of data files by said selection means is made by comparing the coding format of the data files contained on said information carrier with the capabilities of said reading apparatus for playing such a coding format.

It is advantageous to base the selection of the data files on the coding format (MP3, MPEG-2, WAV, JPEG, MPEG-4. . . ), since the capabilities of the reading apparatus to play a particular coding format are easily identified by the coding formats it supports.

In a particular embodiment, the user interface system comprises classification means for classifying the selected data files according to their content type.

In the table of contents, this classification can create sub-sections that group together data files having the same content type (audio, video, still pictures . . . ). This classification eases the selection done by the user in the table of contents of a particular data file to be played.

In a particular embodiment, the user interface system comprises classification means for classifying the selected data files according to their coding format or according to a quality criterion.

In the table of contents, this classification allows the creation of additional sub-sections that group together data files, from among a set of data files having a same content type, i.e. files having a same coding format (MP3, MPEG-2, WAV, JPEG, MPEG-4 . . . ), a same quality criterion (for example based on the bit rate or the spatial resolution), or a same spatial resolution (HDTV, VGA, QCIF, . . . ). This classification eases a selection made by the user in the table of contents of data files having specific criteria.

In a particular embodiment, the user interface system comprises means for downloading a plug-in allowing to play data files contained on said information carrier and considered non-playable according to initial capabilities of said reading apparatus.

In downloading the missing plug-ins, for example on a network such as the Internet, this additional feature renders it possible to upgrade the capabilities of the reading apparatus. The downloading of a particular plug-in may be decided on if the table of contents presents data files that are not supported by the reading apparatus.

In a particular embodiment, the presentation means comprise code instructions stored in a data file for describing the rules of design of said table of contents.

The use of such a specific data file allows an easy change in the design of the table of contents, for example in downloading a new file on a network or on the information carrier itself.

The invention also relates to an apparatus for reading an information carrier, comprising a user interface system as described above.

Such an apparatus may correspond to a DVD home player/writer, a PDA (portable digital assistant), or a mobile phone comprising a information carrier player.

The invention also relates to a method of interfacing for presenting to a user the contents of an information carrier intended to be inserted into a reading apparatus, said information carrier containing data files having different content types and different coding formats, said method of interfacing comprising:
a selection step for selecting a set of data files, complying with the capabilities of said reading apparatus to play such data files, from among data files contained on said information carrier,
a presentation step for presenting a table of contents derived from the selected data files, said table of contents being intended to be presented to the user.

This method comprises the set of processing steps implemented by the processing means of the user interface system according to the invention described above.

Detailed explanations and other aspects of the invention will be given below.

### BRIEF DESCRIPTION OF THE DRAWINGS

The particular aspects of the invention will now be explained with reference to the embodiments described hereinafter and considered in connection with the accompanying drawings, in which identical parts or sub-steps are designated in the same manner:

FIG. 1 depicts the general embodiment of a user interface system according to the invention,

FIG. 2 illustrates the processing of a user interface system according to the invention with an example.

### DETAILED DESCRIPTION OF THE INVENTION

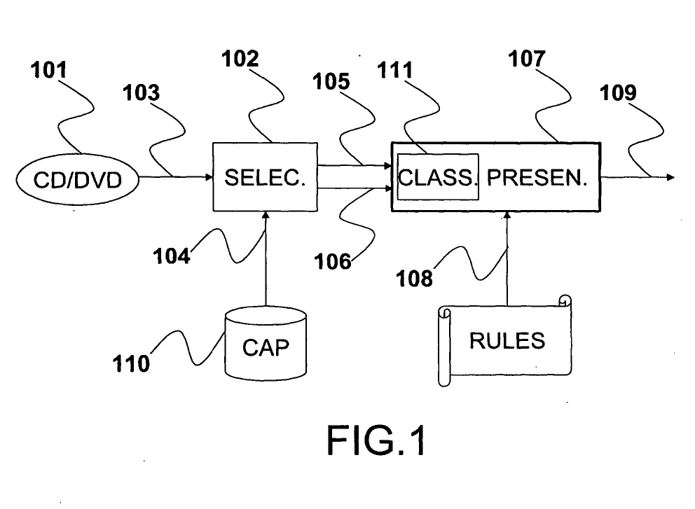

FIG. 1 depicts the general embodiment of a user interface system according to the invention. This user interface system aims at presenting to a user the contents of an information carrier 101 intended to be inserted into a reading apparatus (not represented). The information carrier is, for example, an optical disc on which arbitrary data can be stored.

The user interface system comprises selection means 102 for selecting a set of data files, from among data files 103 contained on the information carrier and complying with the capabilities of said reading apparatus to play such data files. The set of data files 103 contained on the information carrier 101 is explicitly contained in an input TOC file (Table of Contents) itself stored on the information carrier. Alternatively, the set of data files 103 contained on the information carrier may be derived from a file system in the reading apparatus. The capabilities 104 of the reading apparatus are supposed to be known and are stored, for example, in a memory device 110. These capabilities signify which coding formats and content types of data the reading apparatus can support, i.e. which type of data files are playable by the reading apparatus.

The selection means 102 are in charge of selecting a set of data files from among data files 103 whose contents can be played on the reading apparatus, considering the stored capabilities 104 of said apparatus. In particular, the selection of data files by said selection means 102 can be done by comparing the coding format of the data files contained on said information carrier with the capabilities of said reading apparatus for playing such a coding format.

The selection means 102 generate a list 105 of data files playable on the information carrier and a list 106 of data files unplayable on the information carrier.

The list of data files 105 and 106 are then separately processed by presentation means 107, which are in charge of presenting a table of contents composed built from the selected data files 105 and/or 106. To this end, presentation means 107 comprise code instructions 108 stored in a specific data file for describing the design rules (graphical arrangement, colours, . . . ) of the table of contents to be presented to the user. The code instructions are executed by a signal processor embedded in the reading apparatus. The specific data file for describing the rules of design advantageously conforms to an XML-based language (for example the SMIL language). Such a language allows to define a synchronization between the different data files contained on the information carrier. This specific data file may be loaded from the information carrier itself, or downloaded from a web site (for example the web site supported by the publisher of the information carrier).

Additionally, the user interface system comprises classification means 111 in charge of categorizing the contents of each list of data files 105 and 106. These classification means are in charge of defining sub-lists of playable (or unplayable) data files to be presented to the user. In particular, classification means are dedicated to classifying the selected data files 105 or 106 according to their content types. This renders it possible to present to the user a list of playable (or non-playable) data files which are classified according to their content types (audio, video, still pictures . . . ).

Additionally, the classification means are in charge of defining sub-lists among the sub-lists previously classified according to their content types. In particular, classification means are dedicated to classifying the selected data files 105 or 106 also according to their coding formats. This enables the user to identify, among data files having the same content type, data files having the same coding format. Alternatively, data files having a same content type may also be classified according to a quality criterion such as the resolution (HDTV, VGA, QCIF . . . ), or the bit rate. The user can thus select which data files will be played on his reading apparatus. For example, the user will advantageously select video playable data files having the highest resolution (e.g. HDTV video).

In a preferred embodiment, the user interface system comprises means (not represented) for downloading a plug-in (i.e. a software, or a library) allowing to play data files contained on said information carrier and considered unplayable according to initial capabilities of the reading apparatus. Once downloaded, the plug-in is locally stored in the reading apparatus, and the capabilities 104 are updated.

The missing plug-in may be downloaded at the request of the user when looking at the presented table of contents of unplayable data files. Alternatively, the plug-in may be automatically downloaded by the user interface system without user interaction.

The plug-in may be, for example, downloaded from a web site supported by the publisher of the information carrier or by the manufacturer of the reading apparatus.

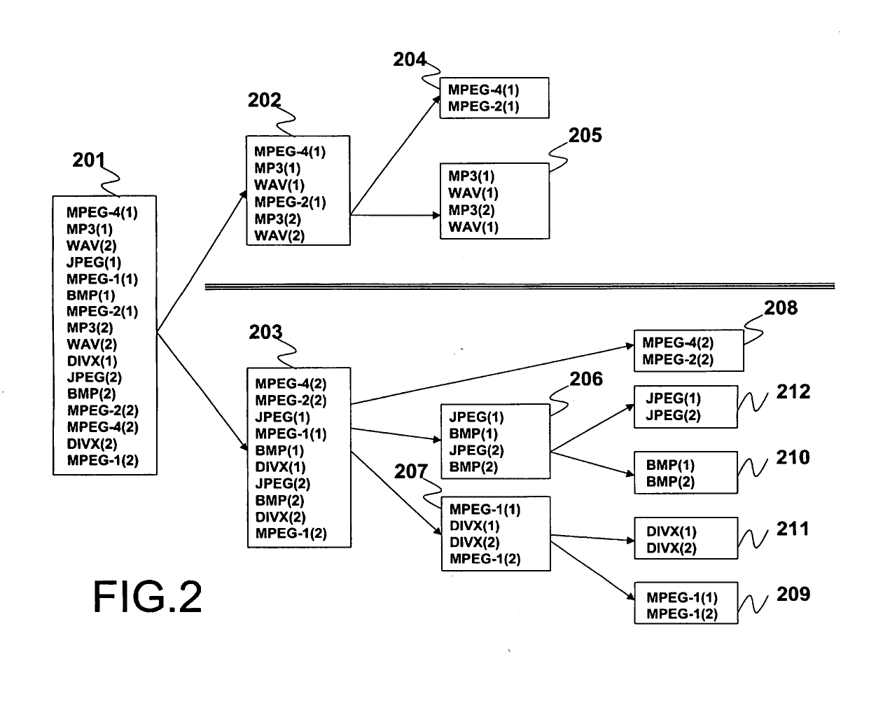

FIG. 2 illustrates the user interface system processing with an example. In this example, the user interface system aims at presenting to a user the contents 201 of an information carrier inserted into a reading apparatus, taking into account the capabilities of the reading apparatus.

The information carrier contains data files having different content types and different coding formats (video: MPEG-1/MPEG-2/MPEG-4/DIVX, audio: WAV/MP3, pictures: JPEG/BMP). It is assumed that the capabilities of the reading apparatus are such that only MPEG-2/MPEG4/MP3/WAV coding formats are supported, but HDTV resolution is not supported for MPEG-2/MPEG4 video data files.

Selection means 102 described above allow to create a first list of data files 202 considered playable by the reading apparatus. The list 202 contains only data files whose coding formats are supported by the reading apparatus.

Selection means 102 also allow to create a second list of data files 203 considered unplayable by the reading apparatus. The list 203 contains data files whose coding formats are not supported by the reading apparatus. Note that data files MPEG-4(2) and MPEG-2 (2) having HDTV resolution are considered not playable even though MPEG4 and MPEG-2 coding formats are supported.

Classification means described above allow to create sub-lists from the list of data files 202, a sub-list 204 gathering the data files of the same content type (i.e. video content type not having a HDTV resolution), and a sub-list 205 gathering the data files of the same content type (i.e. audio content type).

Similarly, classification means allow to create sub-lists from the list of data files 203, a sub-list 208 gathering the data files of the same content type (i.e. video content type having a HDTV resolution), a sub-list 206 gathering the data files of the same content type (i.e. picture content type), and a sub-list 207 gathering the data files of the same content type (i.e. video content type).

Classification means also allow to create sub-lists from the list of data files 206, a sub-list 212 gathering the data files of the same coding format (i.e. JPEG coding format), and a sub-list 210 gathering the data files of the same coding format (i.e. BMP coding format).

Similarly, classification means also allow to create sub-lists from the list of data files 207, a sub-list 211 gathering the data files of the same coding format (i.e. DIVX coding format), and a sub-list 209 gathering the data files of the same coding format (i.e. MPEG-1 coding format).

Different display levels of table of content to be presented to the user are thus created by the user interface system. When presented, the data files from a given sub-list are for example identified by the name of the singer, the title of the song, the title of the movie, or the name of the picture.

Additionally, the user interface system comprises interaction means for browsing in the presented table of contents, and interaction means for defining the definition criteria of the table of contents. Thus, the user is able to select a table of contents of playable data files presented according to sub-list 202, or according to the classification of sub-lists 204-205. The user may also select one or a plurality of the sub-lists 208-209-210-211-212 so that a request is generated for downloading the missing plug-ins which allow to play the corresponding coding formats.

Due to editing, a given data file contained on the information carrier may include data files of different content types and different coding formats. For example, a single video data file may combine MPEG-2 video with MP3 audio such that the MP3 audio should be played along with the MPEG-2 video (replacing any audio multiplexed with the video). Similarly, a sequence of still pictures could be combined with an audio file, so that the audio plays as the still pictures are displayed.

Additionally, for these mixed data files, the user interface comprises processing means for mapping these data files onto the basic types. Thus, a title that includes both audio and video should be treated as video, a title that includes audio with still pictures may also be considered as video.

Mixed titles of which parts of the contents are not supported by the reading apparatus should be identified in the presented table of contents, so that the user can see the contents that can be played and also the contents not supported by the reading apparatus.

The classification of a mixed content title may change if some parts are not supported, e.g. a title with audio and still pictures becomes an audio title if the still picture format is not supported.

The user interface system according to the invention may be implemented in an information carrier reading apparatus (DVD home player/writer, PDA, mobile phone . . . ), for example for reading an optical disc (DVD) or memory storage device (Solid state memory cards, removable hard discs).

The user interface system may be implemented by means of hardware elements (such as wired electronic circuits, memories, signal processors . . . ), or alternatively by means of software elements such as computer programs comprising code instructions stored in a memory device, said code instructions being executed by a signal processor.

1. A user interface system for presenting to a user the contents of an information carrier (101) intended to be inserted into a reading apparatus, said information carrier (101) containing data files having different content types and/or different coding formats, said user interface system comprising:
selection means (102) for selecting a set of data files (105), complying with the capabilities (CAP) of said reading apparatus to play such data files, from among data files (103) contained on said information carrier (101),
presentation means (107) for presenting to said user, a table of contents from the selected data files (105).

2. A user interface system as claimed in claim 1, wherein the selection means (107) comprise comparison means for comparing the coding format of the data files (103) contained on said information carrier with the capabilities (CAP) of said reading apparatus for playing such a coding format.

3. A user interface system as claimed in claim 2, comprising classification means (111) for classifying the selected data files (105) according to their content type.

4. A user interface system as claimed in claim 3, comprising classification means (111) for classifying the selected data files according to their coding format or according to a quality criterion.

5. A user interface system as claimed in claim 4, comprising downloading means for downloading a plug-in allowing to play data files contained on said information carrier and considered non-playable according to initial capabilities (CAP) of said reading apparatus.

6. A user interface system as claimed in claim 5, wherein the presentation means comprise code instructions stored in a data file for describing the rules of design of said table of contents.

7. An apparatus for reading an information carrier (101) intended to contain data files having different content types and/or different coding formats, said apparatus comprising:
a memory device for storing coding formats and content types of data, referred to as capabilities (CAP), which are playable by said apparatus,
a user interface system comprising:
a) means (102) for selecting, from among data files (103) contained on said information carrier (101), a set of selected data files (105) complying with said capabilities (CAP),
b) means (107) for presenting a table of contents from said set of selected data files (105).

8. An apparatus as claimed in claim 7, wherein said means (102) for selecting comprise means for comparing the coding format of the data files (103) contained on said information carrier with said capabilities (CAP).

9. An apparatus as claimed in claim 8, further comprising means (1 1 1) for classifying the selected data files (105) according to their content type.

10. An apparatus as claimed in claim 9, further comprising means (1 1 1) for classifying the selected data files according to their coding format.

11. An apparatus as claimed in claim 9 or 10, further comprising means (111) for classifying the selected data files according to a quality criterion.

12. An apparatus as claimed in claim 7, further comprising means for downloading a plug-in for playing data files which are considered non-playable according said capabilities (CAP).

13. An apparatus as claimed in claim 12, further comprising means for updating said capabilities (CAP) according to the content type and/or coding format playable by said plug-in.

14. An apparatus as claimed in claim 7, wherein said means (107) for presenting comprise code instructions stored in a data file for describing the rules of design of said table of contents.

15. A method of interfacing for presenting to a user the content of an information carrier inserted into a reading apparatus, said information carrier containing data files having different content types and/or different coding formats, said method comprising:
a selection step for selecting, from among data files contained on said information carrier, a set of selected data files complying with coding formats and content types of data which are playable by said reading apparatus,
a presentation step for presenting a table of contents from said set of selected data files.
